(19) United States
(12) Patent Application Publication
(10) Pub. No.: US 2012/0192083 A1
(43) Pub. Date: Jul. 26, 2012

(54) METHOD AND SYSTEM FOR ENHANCED ONLINE SEARCHING

(75) Inventors: Kai Y. Eng, Atlantic Highlands, NJ (US); Pramod Pancha, Belle Mead, NJ (US)

(73) Assignee: Bellmar Communicatios LLC, Chicago, IL (US)

(21) Appl. No.: 13/013,085

(22) Filed: Jan. 25, 2011

(51) Int. Cl. G06F 3/01

(52) U.S. Cl. 715/749

(57) ABSTRACT

A user performing a search on a computing device, for example with a browser application, is provided with one or more software buttons on the display of the device. The buttons are created based on the subject matter of his search. As the user searches, his queries are stored. Should the user actuate a software button, real time communication, for example a telephone call, is established with an adviser, who receives a copy of the user's search queries on his computing device.

### BACKGROUND OF THE INVENTION

The present invention relates generally to online searching and, more particularly, concerns enhancement of the searching experience through the use of an externally provided, actuable executable object, such as a software button, to provide assistance by a human adviser.

Online searches in accordance with the present invention are provided through the use of a “computing device”, which will be understood to include not only an actual computer, such as a personal computer, but also any kind of intelligent device, such as a personal digital assistant (PDA) or a smart telephone, capable of Internet browsing. For voice communications, the device will need to be capable of sensing sound, as through a microphone, and producing sound, as through a speaker or earphone. Communication takes place through a network, such as the Internet and, in some instances, through the public service telephone network (PSTN).

Online searching, for example on the Internet, is by now a common experience. Even competent searchers spend endless hours seeking useful information on a wide range of subjects. A great deal of time could be saved if a searcher had immediate access to a human adviser or expert for assistance on the subject being searched.

In our co-pending U.S. patent application Ser. No. 12/603,683, filed Oct. 22, 2009, we disclose a method and system for facilitating telephone calls that convey the context of the call to the called party. The disclosure of that patent application is incorporated herein by reference in its entirety. In accordance with one embodiment of the invention disclosed in that patent application, a software button is utilized on a computing device to initiate a call. Activation of the button causes a “soft phone” to be downloaded from a server. The soft phone is essentially an executable software agent that operates on the computing device to set up a call to only a specified telephone number. The software agent causes certain call context information to be embedded which is unique to the actuated software button.

In accordance with one aspect of embodiments of the present invention, a user performing a search on a computing device, for example with a browser application, is provided with one or more software buttons on the display of the device. The buttons are created based on the subject matter of his search. As the user searches, his queries are stored. Should the user actuate a software button, real time communication, for example a telephone call, is established with an adviser, who receives a copy of the user's search queries on his computing device.

### BRIEF DESCRIPTION OF THE DRAWINGS

The foregoing description and other objects, features, and advantages of the present invention will be understood more completely from the following detailed description of presciently preferred, but nonetheless illustrative, embodiments in accordance with the present invention, with reference being had to the accompanying drawings, in which:

FIG. 1 is a functional block diagram illustrating the exemplary structure of a system in which the present invention is used;

FIG. 2 is a flow chart illustrating steps which are performed in the system of FIG. 1, in performing a process in accordance with an embodiment of the present invention;

FIG. 3 is a flowchart illustrating the service usage steps between a Sender and a Recipient in a software button communication system; and

FIG. 4 is a functional block diagram of a preferred button service system.

### DETAILED DESCRIPTION OF THE PREFERRED EMBODIMENT

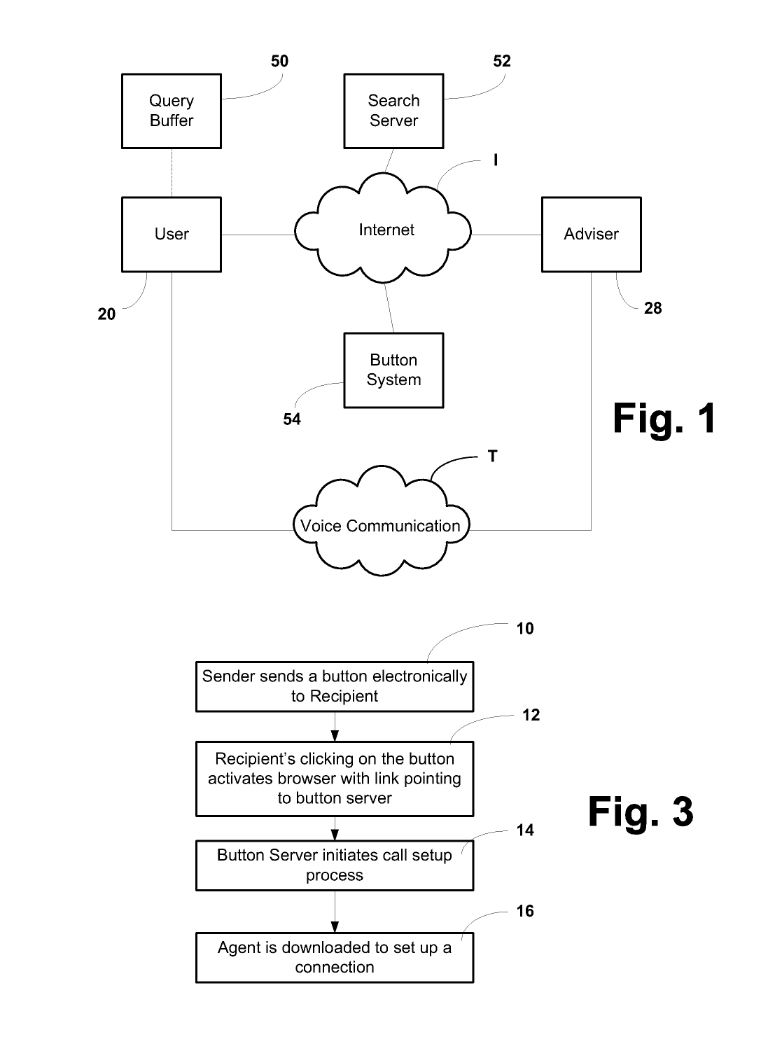

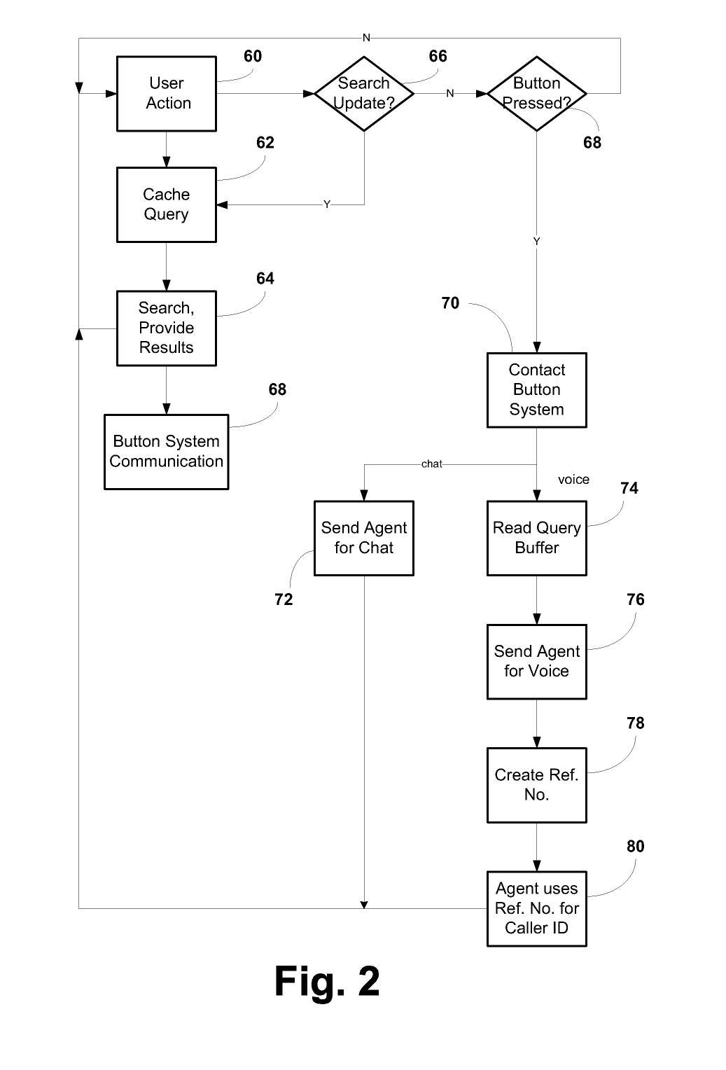

Turning now to the details of the drawings, FIG. 1 is a functional block diagram illustrating the exemplary structure of a system in which the present invention is used. FIG. 2 is a flow chart illustrating steps which are performed in the system of FIG. 1, in performing a process in accordance with an embodiment of the present invention. A user U is connected, through his computing device 20, to a network I, for example, the Internet. Also connected to the network I is an adviser A, through his computing device 28, as well as a search server 52 providing a search engine such as Google, and a button system 54. The user's and adviser's computing devices 20, 28 are also connected to a voice communication (e.g. telephone) network T, which may be a public service telephone network (PSTN), a cellular network, or a digital telephone network, such as a voice over Internet protocol (VoIP) network, or a combination of them. In this embodiment, the computing device 28 is actually a personal computer and a separate PSTN telephone device showing caller ID.

In practice, user U will initiate an online search through his computing device 20 (block 60). For example, user U may be interested in a sports utility vehicle (SUV) but is concerned about gas mileage, and he may be under the impression that a hybrid vehicle would be a good choice. The user might input as his search query “small SUV high gas mileage hybrid.” At block 62, the user's query is cached in a query buffer 50 available on computing device 20. Server 52 then performs a search and returns the results to the user's computing device 20 (block 64). Search server 52 might return the following link as part of its response:

Talk to live adviser “small SUV high gas mileage hybrid” for comparisons and price quotes

Should the user click on this link, he will be directed to a new page containing the following features:
a software button to create a voice connection to a human adviser;
a fill-in block requesting additional information, such as the user's ZIP code or vehicle brand;
a software button to create a live chat between the user and the adviser.
   Should the user provide additional information, this will be detected by a test performed at block 66 to determine whether the user has updated the search, and the updated query is cached (block 62), the search is completed (block 64) and control returns to the user (block 60). In setting up this page, search server 52 communicates with button system 54 (block 68) to create the software buttons which are returned to the user as part of the response.

Should the user not have updated the query, the test at block 66 transfers control to block 68, where a test is performed to determine whether the user has activated a software button. If not, control returns to the user (block 60). When the test at block 68 determines that the user has activated a software button, communication is established with button system 54 (block 70). If the chat button was pressed, button system 54 sends a software agent to computing device 20 causing it to take part in a real time chat session running on computing device 28 (block 72). If the voice connection software button was pressed, button system 54 reads the query cache 50 of the user's computing device 20 (block 74), and sends a software agent to computing device 20 which sets up a voice connection with adviser A via telephone network T (block 76). Button system 54 creates an internal reference number, for example, “1234” for this call (block 78) and causes the voice call to the advisor to be set up with that reference number as the caller ID (block 80). It then sends a message to the adviser's computing device 28 containing the reference number and the user's query. In the present instance, the advisers computing device might display the message:

From Caller ID #1234: Small SUV high gas mileage hybrid.

Thus, the advisor can see the original search words written by the user, as the call comes in to his telephone. Equipped with this context information, the advisor is in a much better position to help the user.

It is contemplated that the query buffer and its communication with the button system 54 could be provided by a small application installed as a plug-in in the browser running on computing device 20. It is also contemplated that communication between button system 54 and the adviser's computing device 28 would be via a continuous real-time instant messaging session, which can be implemented completely independently of the telephone communication. To receive the telephone communication, the adviser need only have a telephone with a caller ID display.

Although the invention has been described in terms of a system providing commercial information, those skilled in the art will appreciate that it is useful in any search environment. For example, it could find use in an academic environment, where the user is a student or scholar performing academic research and is in need of assistance from an expert in a particular area of knowledge, improve his research. The invention would permit the searcher to communicate personally with an expert in his field of search, permitting detailed discussion of the project and focusing the research.

The terminology defined in this paragraph will be used consistently herein. A button is sent from a “Sender” to a “Recipient.” When clicking on a button, the Recipient is attempting to initiate a communication, for example, a call to the Sender. Thus, when a call is established, the (button) Recipient is the “Caller” (making the call), and the (button) Sender is the “Receiver” (of the call). Recipient and Sender are associated with the button operation, and Caller and Receiver are associated with the call session.

Making a communication connection with another party typically means making a telephone call (PSTN, cell or VoIP), sending an SMS (Short Message Service) message on a cell phone, sending an Instant Message (IM) on a computer or sending an email. In each of these examples, a Caller, who initiates the call or the connection (real-time or messaging) with his telephone or computing device, makes a clear choice of the connection or service type to be used (i.e., phone, email, IM or SMS). Depending on the service type selected, the resulting connection is made to the appropriate receiving device (phone, computer, email box, etc.) used by the Receiver, who is the intended recipient of the call. Moreover, the contact service type may be influenced and/or selected based upon any combination of parameters set or selected by the contacted party, the party doing the search, or the search terms specified. For example, certain key terms in the search could cause a specific type of contact.

FIG. 3 is a flowchart illustrating the service usage steps between a Sender and a Recipient in a software button communication system. The process begins at block 10 when the Sender sends a software button to a Recipient's computing device (in our case via search server 52). When the Recipient actuates the received button by clicking on it (block 12), he can initiate a call or connection to the Sender, and the button server initiates call set up at block 14. At block 16 a software agent is downloaded to the Recipient from the button server to set up the connection on his computing device. The process ends at block 14. No preinstalled software is required on the Recipient's computing device other than a standard Internet browser.

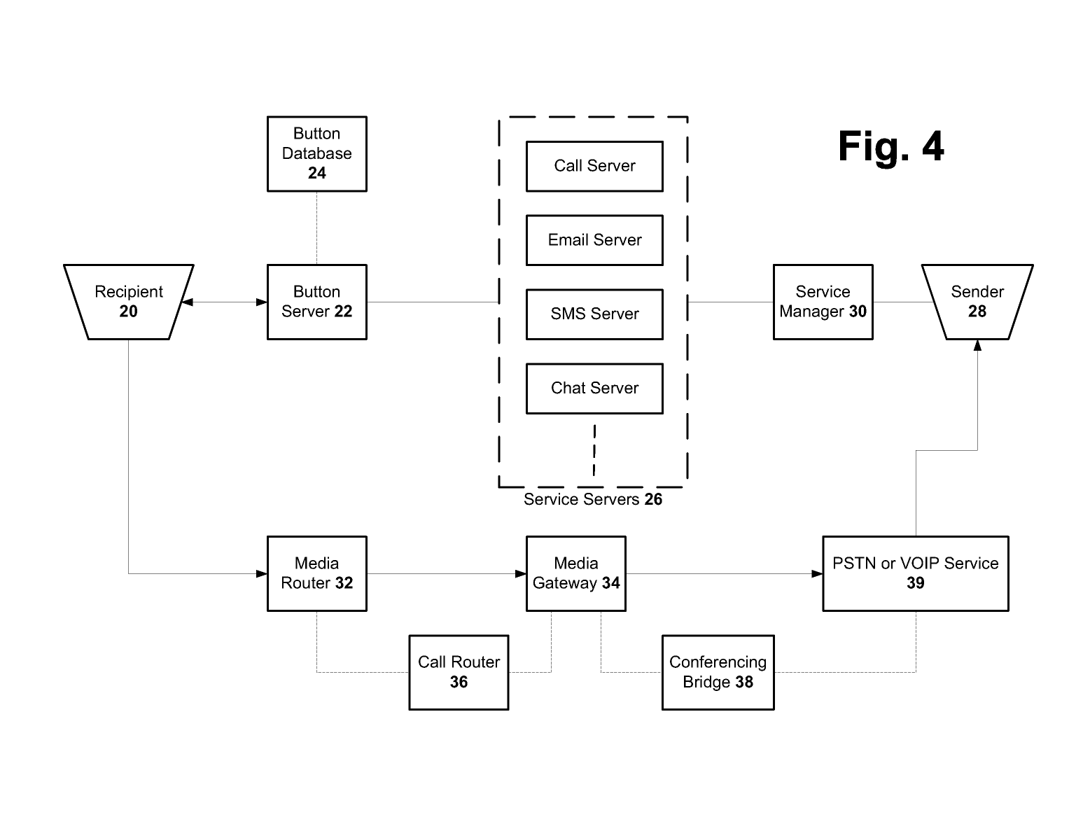

FIG. 4 is a functional block diagram of a preferred button service system 54. A button received by a Recipient's computing device 20 is essentially a website link to a Button Server 22. In addition to the Button Server address, the button is also encoded with unique button identification (BID). When the button is clicked, the Recipient's web browser opens a link directed to the Button Server as equivalent to a call request. When the BID is received by Button Server 22, a lookup is done immediately in a button database 24 accessible to Button Server 22, using the BID, to retrieve the state of the Button.

The service servers 26 shown in FIG. 2 are used to provide various services or connections. The Sender's computing device 28 has access to servers 26 through a Service Manager 30, in order to set up various services. For example, the Sender needs to provide telephone numbers and e-mail addresses to service servers 26. For real time services, e.g., voice or video, media packets are transmitted from the Recipient's computing device 20 to a Media Router 32 and media gateway 34 for handling instead of going through the Button Server. Also included are a Call Router 36 and a Conference Bridge 38 for handling these routine communication functions. It should be noted that there are also non-connection oriented services possible in this system, e.g. Sender Location or Presence. The Service Servers 26 may also include a Conferencing Server.

In this example, the sender is Adviser 28, but it should be appreciated that, in practice, the system will have many such senders, each a subscriber to the system and each capable of controlling the buttons created for him. He could, for example, have the button create a different type of connection at certain times, such as a telephone connection during business hours and an e-mail or SMS connection at other times.

In configuring a particular communication option, a Sender obviously has to provide appropriate parameters to use. For example, the Sender has to specify a phone number for calling, an email address for email, and so on. These parameters are written into button database 24, available to server 22, and they are hidden from the users. The parameters provided by a subscriber can be changed anytime.

Although preferred embodiments of the invention have been disclosed for illustrative purposes, those skilled in the art will appreciate that many additions, modifications, and substitutions are possible without departing from the scope and spirit of the invention as defined by the accompanying claims.

What is claimed:

1. A method for enhancing online searching by a user making use of a computing device, comprising the steps of:
providing to the user's computing device a software button originating remote from his computing device which is constructed based upon the user's search subject matter, the software button being associated with a second device in use by an adviser on the subject matter, the button being actuable by the user; and
upon actuation of the software button by the user, downloading an executable agent to his computing device, effective to establish a connection between the user's computing device and the second device.

2. The method of claim 1 further comprising caching at the user's computerized device search queries which he makes and transmitting at least one of the cached search queries to the second device after the user actuates the software button.

3. The method of claim 1 wherein the connection includes voice communication.

4. The method of claim 3 wherein the second device includes a telephone with caller ID recognition, the method further comprising generating a reference number associated with the user's search and, after the user actuates the software button, sending the reference number to the second device as a caller ID.

5. The method of claim 4 further comprising caching at the user's computerized device search queries which he makes and transmitting at least one of the cached search queries together with the reference number to the second device after the user actuates the software button.

6. The method of claim 5 further comprising, at the second device displaying the transmitted search queries in association with the reference number.

7. A system for enhancing online searching by a user making use of a computing device, comprising:
a generator of an executable agent constituted to establish a communication connection between the user's computing device and a second device determined from the subject matter of the user's search; and
a software button which is associated with the second device, is available to the user's computing device, is actuable by the user of the second device, and is constructed so that it causes the executable agent to be downloaded from the generator to the calling computing device.

8. The system of claim 7 further comprising a cache available to the computing device for storing search queries made by the user, the executable agent being constructed to cause at least one cached query to be sent to the second device.

9. The system of claim 7 wherein the communication connection includes voice communication.

10. The system of claim 9 wherein the second device includes a computerized device and a separate telephone with caller ID recognition.

11. The system of claim 9 wherein the second device includes a telephone with caller ID recognition, the system further comprising a generator a reference number associated with the user's search and, means in the downloaded software agent sending the reference number to the second device as a caller ID.

12. The system of claim 10 further comprising a cache available to the computing device for storing search queries made by the user, the executable agent being constructed to cause at least one cached query to be transmitted to the second device together with the reference number.

13. The system of claim 12 further comprising a display control at the second device constructed to display the transmitted queries to be displayed in association with the reference number.

14. A method of responding to a search by a user, the method comprising:
returning content located by the search, based upon search terms contained therein, and returning an actuatable software button associated with each of plural items of returned content;
upon actuation of at least one of said software buttons, transmitting said search terms to a contacted party, and establishing contact between said user and said contacted party.

15. The method of claim 14 wherein said contacted methodology is selected based upon preferences said by the user, the contacted party, or the search terms.

16. The method of claim 14 wherein said results returned by said search contain said actuatable software button and some do not.

17. The method of claim 16 wherein said actuatable software button is configured such that upon actuation, a third party server is contacted and an executable software agent is downloaded to a computing device said user is using.

18. The method of claim 16 wherein actuation of said software button causes said search terms to be transmitted to a contacted party.
